(19) United States
(12) Patent Application Publication
(10) Pub. No.: US 2015/0331356 A1
(43) Pub. Date: Nov. 19, 2015

(54) DEVELOPER CONTAINER AND IMAGE FORMING APPARATUS

(71) Applicant: CANON KABUSHIKI KAlSHA, Tokyo (JP)

(72) Inventor: Masaki Kakitani, Abiko-shi (JP)

(21) Appl. No.: 14/695,606

(22) Filed: Apr. 24, 2015

(30) Foreign Application Priority Data
May 16, 2014 (JP) 2014-101987

(51) Int. Cl. G03G 21/12

(52) U.S. Cl. CPC G03G 15/0831

(57) ABSTRACT

A developer container, comprising:
an accommodating portion accommodating fallen developer;
a first optical unit guiding detection light;
a second optical unit disposed as opposed to the first optical unit, and guiding the detection light to the outside of the accommodating portion;
a space provided between the first optical unit and the second optical unit, and in which the developer accumulates;
a casing having an opening for communicating with the space, and covering the peripheral of the space; and
an outlet disposed at a position lower than the opening,
wherein an angle formed by a straight line connecting a point closest to the opening on opposed surface areas of the first optical unit and the second optical unit and a point farthest from the opening on the opposed surface areas and the horizontal direction is greater than the repose angle of the developer.

### BACKGROUND OF THE INVENTION

1. Field of the Invention

The present invention relates to a developer container which detects an amount of developer stored therein and an image forming apparatus provided with the developer container.

2Description of the Related Art

An image forming apparatus using an electrophotographic system is provided with one or more image bearing members (photosensitive members). Around an image bearing member, a charging unit, an image exposure unit, a developing unit and a cleaning unit are provided, thereby a toner image of a single color formed on each image bearing member is superimposed and transferred (primary transfer)onto an intermediate transfer member of a belt member. Transfer residual toner remaining slightly on the image bearing member is collected by the cleaning unit, is conveyed by a recovery toner conveying unit and is stored after being dropped into the recovery toner container.

A visible image born on the intermediate transfer belt is secondarily transferred on the transfer sheet such as a plain paper to obtain a recorded image. Transfer residual toner remaining slightly on the intermediate transfer belt is collected by the cleaning unit of the intermediate transfer member, is conveyed by the recovery toner conveying unit and is stored after being dropped into the recovery toner container. A transfer paper on which a visible image is transferred from the intermediate transfer belt is conveyed to the fixing device and is ejected after receiving fixation of the visible image.

The collected toner stored in the recovery toner container in the process described above is necessary to replace when the collected toner is accumulated at a predetermined amount. A recovery toner detecting unit determines that the collected toner reaches a predetermined amount and it prompts replacement to a user.

Such a conventional recovery toner detecting unit is provided with a light emitting element and a light receiving element around the recovery toner container and a prism at the recovery toner container having a light-emitting side reflecting surface (first reflecting surface) and a light-receiving side reflecting surface (second reflecting surface) which are respectively opposed to light emitting element and a light receiving element. Furthermore, U.S. Patent Application Publication No. 2014/016977 A1 discloses that the first reflective surface and the second reflective surface are arranged in the vertical direction and a space is provided for detecting that the toner enters an optical path and the amount of collected toner reaches a predetermined amount by shielding the optical path. With this configuration, toner is gradually deposited on the second reflective surface, eventually the toner covers the second reflective surface, thereby the toner blocks the detection light. Thus, it is determined that the toner stored in the recovery toner container reaches a predetermined amount.

However, in the configuration of the above Document, although the toner is gradually deposited on the second reflective surface, the deposited toner may reach the end portion of the first reflective surface located above the second reflective surface before the toner covers the entire area of the second reflective surface. In this case, the portion which the toner enters between the first reflective surface and the second reflective surface is covered. Thereby it is inhibited that the toner is accumulated on the second reflective surface and there is a possibility of not being able to detect that the amount of the toner reaches a predetermined amount.

### SUMMARY OF THE INVENTION

The present invention is configured to properly deposit the toner on the detection unit and surely detects that the amount of toner reaches a predetermined amount.

A representative configuration of the present invention is A developer container, comprising:

an accommodating portion which has a chute through which developer falls and which accommodates the developer which has fallen;

a first optical unit which forms an optical path for guiding detection light inside the accommodating portion;

a second optical unit which is disposed so as to be opposed to the first optical unit, and which forms an optical path for guiding the detection light guided by the first optical unit to the outside of the accommodating portion;

a space provided at the optical path between the first optical unit and the second optical unit, and in which the developer is able to accumulate;

a guiding portion which guides the developer to the space;

a casing portion which has an opening for communicating with the space, and which covers the peripheral of the space; and

an outlet which is disposed at a position lower in the direction of gravity than the opening, and through which the developer guided into the casing portion is discharged,

wherein the first optical unit and the second optical unit are configured such that in a vertical cross section including the first optical unit and the second optical unit, an angle formed by a straight line connecting a point closest to the opening on opposed surface areas of the first optical unit and the second optical unit and a point farthest from the opening on the opposed surface areas, and the horizontal direction is greater than the repose angle of the developer.

Further features of the present invention will become apparent from the following description of exemplary embodiments with reference to the attached drawings.

### BRIEF DESCRIPTION OF THE DRAWINGS

FIG. 1 is an overall view of an image forming apparatus of an embodiment of the present invention.

FIG. 2 is a diagram showing a conveying route from the image forming apparatus to a developer container.

FIG. 3 is an overall view of the developer container.

FIG. 4 is a side view of the developer container.

FIG. 5 is a cross-sectional view showing the configuration of a developer amount detecting system.

FIG. 6 is a perspective view showing the appearance of a prism unit.

FIG. 7 is a diagram for explaining the diffusion angle of the toner.

FIG. 8 is a diagram for explaining the repose angle of the toner.

FIG. 9 is a cross-sectional view showing the detailed structure of the prism unit.

FIG. 10 is a diagram showing a state in which the collected toner has reached a predetermined amount.

FIGS. 11A, 11B, 11C and 11D are diagrams showing positional relationships of the prisms.

### DESCRIPTION OF THE EMBODIMENTS

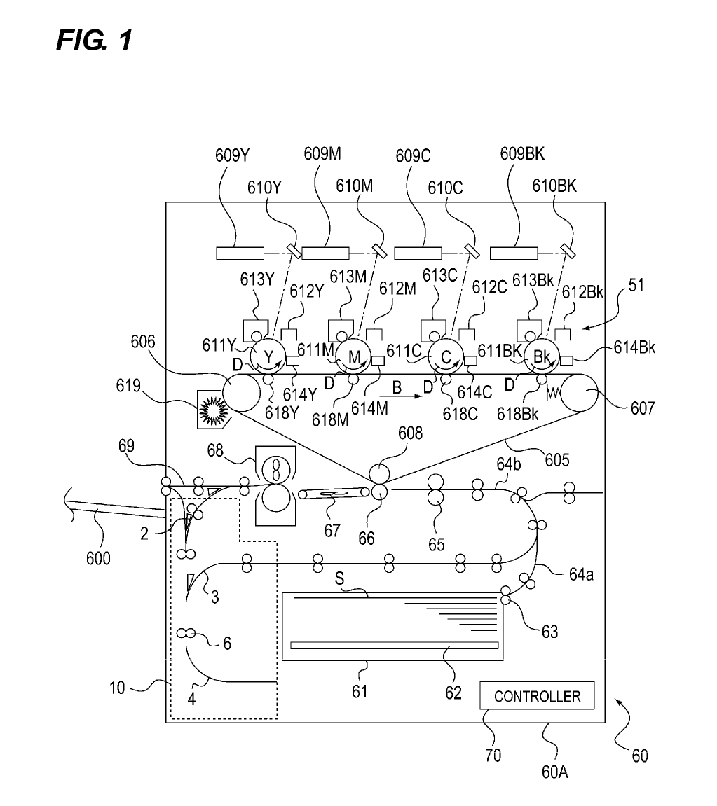

An embodiment of the present invention will be explained in detail with reference to the drawings. It is not intended to limit the scope of the present invention to the dimensions, materials, shapes, their relative positions and so on of the components written in this embodiment as long as there is no specific description since these factors should be changed depending on the configuration or various conditions of an apparatus to which the present invention applies. Although the toner is included in the developer in general, the toner and the developer are expressed to mean the same powder in the following.

<Image forming apparatus> An image forming apparatus having a developer container according to the present embodiment will be explained. FIG. 1 is an overall view of the image forming apparatus. First, the operation of the image forming apparatus will be explained with reference to FIG. 1.

The image forming apparatus 60 shown in FIG. 1 is a color image forming apparatus using an electrophotographic system. The color image forming apparatus 60 uses an electrophotographic image forming process. As shown in FIG. 1, the image forming apparatus 60 has the main body 60A and the image forming unit 51 is provided inside the main body 60A. The image forming unit 51 includes the photosensitive drum 611 (image bearing member), the primary transfer roller 618 (primary transfer unit) and so on.

Four image forming units 51 are provided for forming toner images of yellow (Y), magenta (M), cyan (C) and black (Bk). Each of the image forming units 51 is the same as other image forming units except for the color of the toner contained in the developing device. Therefore, the subscripts Y, M, C and Bk are omitted in the following description except when necessary.

The image forming units 51 may be incorporated in the main body 60A as a process cartridge. This process cartridge includes the photosensitive drum 611 and a process means acting on this.

The image forming apparatus 60 is an image forming apparatus of a so-called intermediate transfer tandem type in which image forming units of four colors are disposed in a line on the intermediate transfer belt 60. Such type of an image forming apparatus has been a mainstream in recent years since it has excellent performance for cardboard and excellent productivity.

<Conveying process of the sheet material> The recording materials S are stacked on the lifting device 62 in the recording material storage 61. Further, the recording materials S may be stacked on a manual feed tray provided on a side of the main body. The recording materials S stacked on the lifting device 62 are fed by the feed roller pair 63 in accordance with timing of the image formation. The feed roller pair 63 employs friction separation by a separation roller and the like. The recording material S fed by the feed roller pair 63 is conveyed through the conveying path 64a and conveying path 64b to the registration roller 65.

The registration roller 65 is a device for adjusting the relative position of the recording material S and the image. After performing skew correction and timing correction of the recording material S, it is sent to the secondary transfer portion. The secondary transfer portion is a nip portion formed by the inner secondary transfer roller 608 and the outer secondary transfer roller 66 which is opposed to the inner secondary transfer roller 608 for transferring the toner image to the recording material S. The toner image is adhered to the recording material S by applying a predetermined pressure and electrostatic load bias.

<Imaging process> Next, an explanation will be made to the formation of an image which is conveyed to the secondary transfer portion with the same timing as the conveying process of the recording material S conveyed to the secondary transfer portion as explained above. The image forming unit 51 includes mainly the photosensitive drum 611, the charging device 612, the exposure device 609, the developing device 613, the primary transfer roller 618 and the photosensitive drum cleaner 614 and the like. Control of each part is performed by the control unit 70 of the image forming apparatus.

The surface of the photosensitive drum 611 is previously charged uniformly by the charging device 612 and the photosensitive drum 611 rotates in the direction of the arrow D. The exposure device 609 exposes the photosensitive drum 611 via the diffraction element 610 based on a received signal indicating image information in order to form an electrostatic latent image. An electrostatic image formed on the photosensitive drum 611 is visualized as a toner image on the photosensitive drum 611 after being developed by the developing unit 613. Then, a predetermined pressure and an electrostatic load bias is applied by the primary transfer roller 618 is given, a toner image is transferred onto the intermediate transfer belt 605.

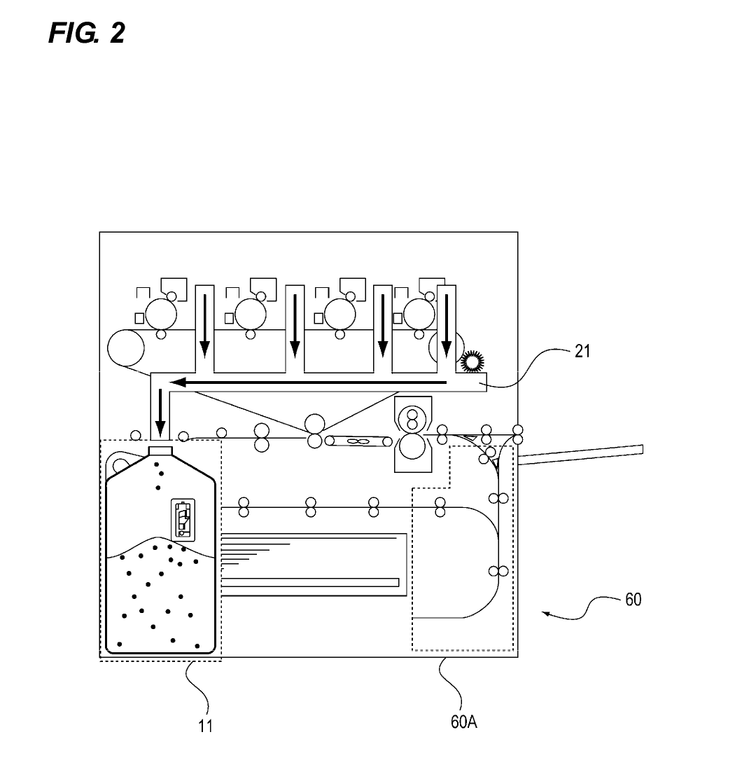

Then, transfer residual toner remaining slightly on the photosensitive drum 611 is collected by the photosensitive drum cleaner 614 for the apparatus to become ready for the next image formation. The collected transfer residual toner is conveyed along the conveying path 21 and falls into the container 11 (developer container) where the toner is stored as shown in FIG. 2. FIG. 2 is a diagram showing a conveying path of the developer from the image forming device to the developer container. FIG. 2 shows a cross section of the image forming apparatus 60 taken along in a different location from FIG. 1.

Then, the intermediate transfer belt 605 will be explained. The intermediate transfer belt 605 is tensioned by rollers such as the drive roller 606, the tension roller 607, the inner secondary transfer roller 608 and so on and is driven to the direction of arrow B. Each of the aforementioned image forming processes of the colors Y, M, C and Bk performed in parallel by the image forming units is carried out at the timing when an image is superimposed on the upstream color images which are primarily transferred on the intermediate belt 605. As a result, a full-color toner image is formed finally on the intermediate transfer belt 605 and is conveyed to the secondary transfer portion.

<Process subsequent to secondary transfer> A full color toner image is secondarily transferred on the recording material S at the secondary transfer portion by the conveying process and the image forming process of the recording material S as explained above. The transfer residual toner remaining slightly on the intermediate transfer belt 605 is collected by the cleaning device 619 of the intermediate transfer belt 605 and is conveyed along the conveying path 21 and falls into the container 11 where the collected toner is stored as shown in FIG. 2.

Thereafter, the recording material S is conveyed to the fixing device 68 by the pre-fixing conveying portion 67. The fixing device 68 melts and fixes a toner image on the recoding material S by applying a predetermined pressure by an opposing roller or a belt or the like and heat by a heat source such as a heater. A selection of the conveying paths of the recording material S having a fixed image obtained in this way is performed so that the recording material S is conveyed either to the discharge conveying path 69 for discharging the recording material S on the discharge tray 600 or to the reverse induction path 2 included in the reverse conveyor 10 when a double-sided image is formed.

When a double-sided image is formed, the recording material S is drawn from the reverse induction path 2 to the switchback path 4. Then, the apparatus performs a switchback operation in which the reversing roller 6 is rotated in a forward direction and a reverse direction. With this operation, the recording material S is reversed such that the front end of the recording material S is placed at the rear end and is conveyed to the image forming unit 51 again via the duplex conveying path 3.

<Developer storage configuration> As shown in FIG. 2, the container 11 for containing the toner T or developer and the conveying path 21 for conveying the collected toner are disposed in the main body 60A. As described above, transfer residual toner remaining slightly on the photosensitive drum 611 is collected by the photosensitive drum cleaner 614. Furthermore, transfer residual toner remaining slightly on the intermediate transfer belt 605 is collected by the cleaning device 619. The collected transfer residual toner is conveyed by the conveying path 21 and falls into the container 11 thereby it is stored and accumulated.

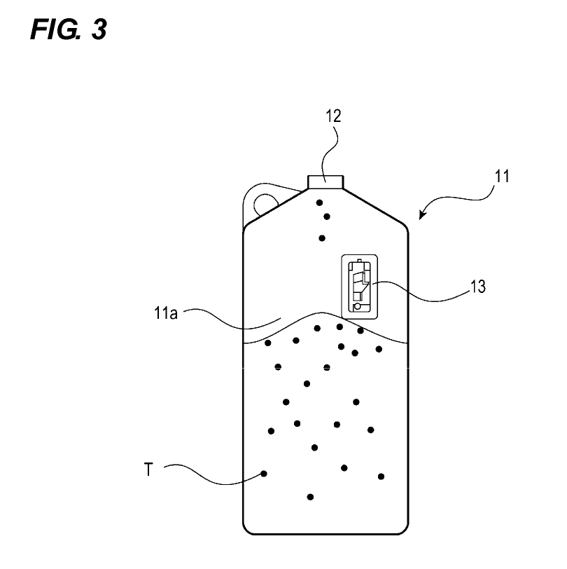

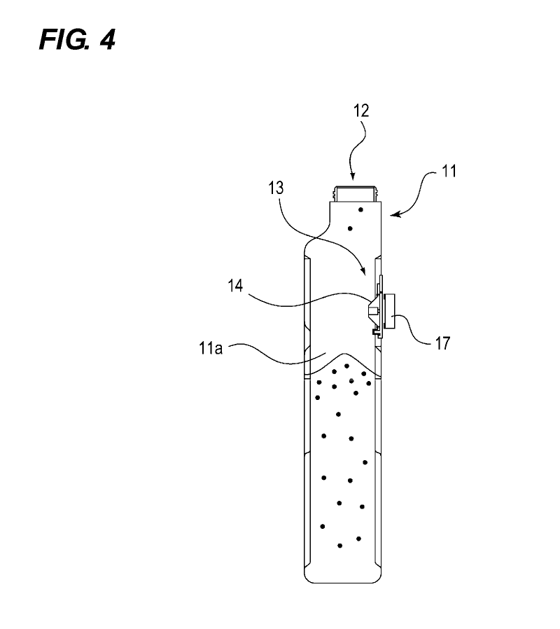

FIG. 3 is an overall view of the developer container. The container 11 shown in FIG. 3 collects the toner T (developer) and the container 11 includes the chute 12 (collecting aperture) through which the collected toner T (developer) is dropped. The dropped toner T is accommodated in the housing portion 11a which is a space inside the container 11. At a position on side of the container 11 closer to the right side of the chute 12 than the center, the prism unit 13 for refracting the light emitted from the reflective sensor (see FIG. 4) is disposed. That is, the position where the prism unit 13 (inlet 23a) is provided does not overlap with the chute 12 in view of the direction of gravity and the prism unit 13 in provided at a position lower than the chute 12 in the direction of gravity.

FIG. 4 is a side view of a developer container. As shown in FIG. 4, the prism unit 13 is disposed so as to enter the inside of the container 11. The prism unit 13 cannot be an obstacle when the container 11 is set in the main body 60A since the prism unit 13 does not protrude from the outer surface of the container 11.

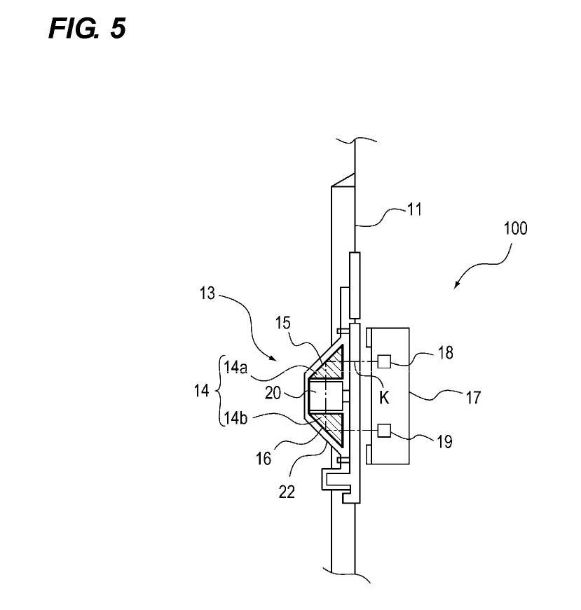

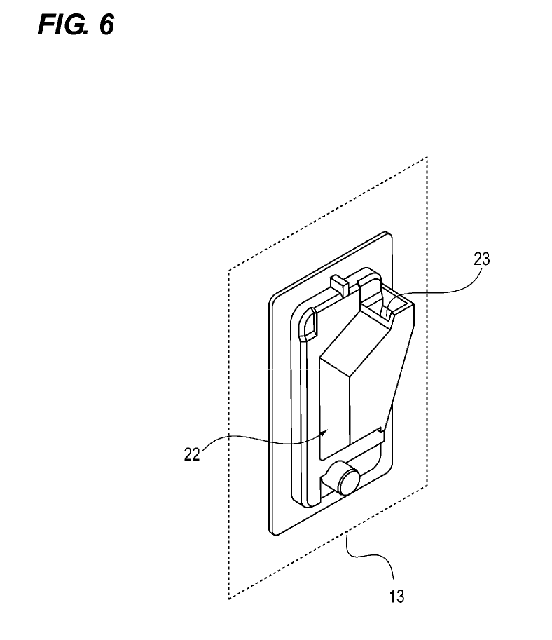

The reflective sensor 17 is disposed at the side of the main body 60A. The reflective sensor 17 is disposed at a position opposed to the prism unit 13 when the container 11 is set at a predetermined position of the main body 60A. It is also possible to dispose the reflective sensor 17 directly on the container 11. However, since the container 11 is a durable component, the present embodiment employs the configuration in which the reflective sensor 17 is disposed on the side of the main body 60A in order not to impair the exchange operability and in order to suppress an increase in the running cost.

<Schematic configuration of the developer amount detecting system> FIG. 5 is a sectional view showing a configuration of the developer amount detection system. The developer amount detection system 100 shown in FIG. 5 includes the prism unit 13 and the reflective sensor 17. The prism unit 13 is detachably attachable to the container 11 and can be easily replaced and cleaned. The prism unit 13 includes the prism 14, the covering member 22 (casing portion) and the introducing member 23 (see FIG. 6). The covering member 22 which covers the periphery of the detection area 20 has the inlet 23a (aperture portion) which communicates with the detection region 20 as described below.

First, the reflective sensor 17 (detection unit) includes the light emitting element 18 which emits detection light and the light receiving element 19 which receives the detection light emitted from the light emitting element 18. When the optical path K from the light emitting element 18 to the light receiving element 19 is blocked by the toner, the reflective sensor 17 detects that the toner inside the container 11 is filled at a predetermined amount. The reflective sensor 17 is disposed outside the container 11. The toner blocks the optical path in the detection area 20 which will be described later.

The prism unit 13 has the prism 14 inside the container 11. The prism 14 is disposed inside the container 11 and is a member defining the optical path K of the detection light. The prism 14 includes the first prism 14a (first optical unit) and the second prism 14b (second optical unit) in the middle of the optical path K. Each of the first prism 14a and the second prism 14b have a reflecting surface for reflecting the detection light. The first prism 14a and the second prism 14b are disposed to be opposed to each other in the vertical direction.

The first prism 14a and the second prism 14b are arranged in the vertical direction. The first prism 14a is disposed at an upper position and the second prism 14b is disposed at a lower position. The first prism 14a has the first reflecting surface 15 for reflecting the detection light as shown by the inclined surface in FIG. 5. The second prism 14b has the second reflecting surface 16 for reflecting the detection light as shown by the inclined surface in FIG. 5.

The arrangement of the first reflecting surface 15, the second reflecting surface 16 and the reflective sensor 17 is as follows. First, the detection light emitted from the light emitting element of the reflective sensor 17 is bent in a substantially vertically downward at the first reflecting surface 15. Then, the light is further bent into the light receiving element 19 of the reflective sensor 17 at the second reflecting surface 16.

The detection area 20 (space) is defined inside the container 11 and is a space defined such that the toner can be stored in the middle of the optical path K. In particular, the detection area 20 is defined between the first prism 14a and the second prism 14b.

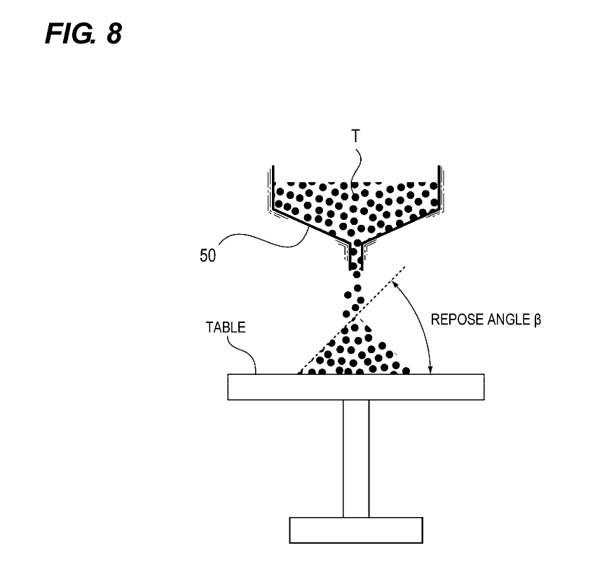

Next, the overall configuration of the prism unit 13 will be explained. FIG. 6 is a perspective view showing an appearance of a prism unit. As shown in FIG. 6, the prism unit 13 has the covering member 22 which covers the prism 14 (see FIG. 5). This covering member 22 prevents the toner which has fallen from the chute 12 (see FIG. 3) from entering the detection area 20 (see FIG. 8) defined by the prism 14 without passing through the introducing member 23 (guide portion). On the other hand, the toner is guided by the introducing member 23 and flows into the detection area 20. The influx toner accumulates in the detection area 20. When the toner accumulates in the detection area 20, the toner blocks the optical path K (see FIG. 5) of the detection light thereby the toner is detected.

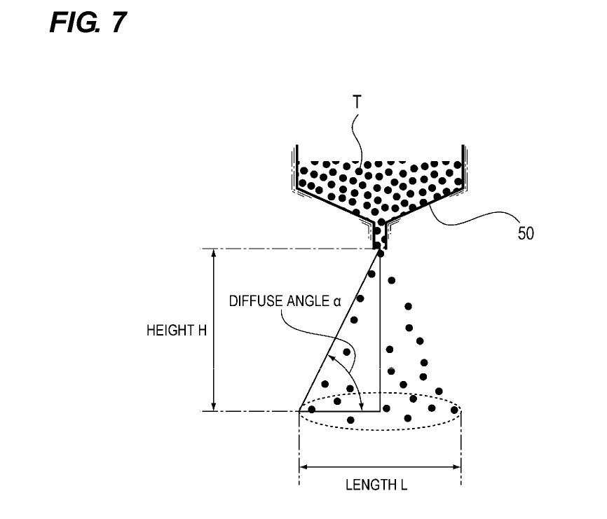

Then, prior to the description of the detailed structure of the prism unit 13 and the specific detection method of the toner, the angles (the diffusion angle α, the repose angle β) which are prerequisite for the determination of the structure will be explained. FIG. 7 is a view for explaining the diffusion angle of the toner. FIG. 8 is a view for explaining the repose angle of the toner.

<Diffusion angle α of the toner> As shown in FIG. 7, when the toner falls freely, the toner does not fall vertically but it falls while diffusing by being affected by air resistance. Therefore, the diffusion angle α as the degree of its diffusion will be defined.

First, as shown in FIG. 7, the toner T is filled in the funnel 50. It is preferable to use the toner actually collected in the container 11 as the toner to be filled in the funnel 50. This is because the toner that has not been used for image forming, that is, the toner stored in the developing device 613 deteriorates less and there is a difference in the way of diffusion between the toner in the developing device 613 and that collected in the container 11. Furthermore, the toner becomes easier to diffuse by sufficiently stirring the toner since the aggregation of the toner is reduced.

By vibrating the funnel 50, the toner gradually falls onto the paper from the tip of the funnel 50. Then, the spread length L of the toner on the paper and the height H between the funnel 50 and the paper are measured in advance. With these values, the angle between the horizontal direction and the diffusion direction of the toner can be obtained. This angle is called the diffusion angle α. In addition, the experiment for determining the diffusion angle α should be preferably carried out under the environmental conditions of high temperature and high humidity since the toner is easier to diffuse under such conditions.

In this embodiment, the measurement conditions of the diffusion angle and the repose angle which will be described later are set as follows. That is, the diffusion angle and the repose angle are measured using the toner collected when a 3% duty image is formed under the environment of temperature of 27.5° and humidity of 80%.

<The repose angle β of the toner> As shown in FIG. 8, the toner T is filled in the funnel 50. It is preferable to use the toner actually collected in the container 11 as the toner to be filled in the funnel 50. This is because the toner that has not been used for image forming, that is, the toner stored in the developing device 613 deteriorates less and there is a difference in its fluidity between the toner in the developing device 613 and that collected in the container 11.

By vibrating the funnel 50, the toner gradually falls onto the table from the tip of the funnel 50 and the toner accumulates on the table. The angle formed between the toner deposited at this time and the surface of the table is the repose angle β.

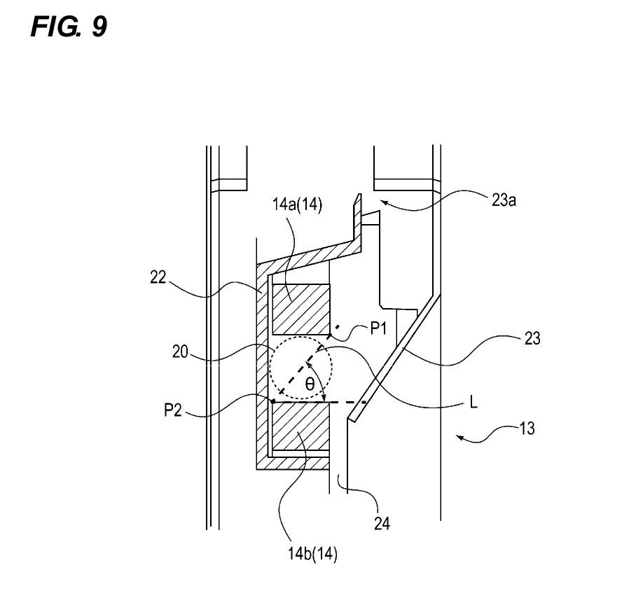

The less the toner T is discharged from the funnel 50, the more easily the toner is deposited. For this reason, it is preferable that the diameter of the tip of the funnel 50 is small and about φ2 to φ3 is employed. By vibrating the funnel 50, the toner can be deposited in a state closer to free fall. In addition, the experiment for determining the repose angle β should preferably be carried out under the environmental conditions of high temperature and high humidity in order to aggravate fluidity of the toner.

<Detailed configuration of the prism unit and detecting method> FIG. 9 is a sectional view showing a detailed configuration of the prism unit. As described above, the side of the prism 14 which is near the chute (see FIG. 3) is covered by the covering member 22. This configuration prevents the toner which has been collected in the container 11 and which has fallen via the chute 12 from directly entering the detection area 20.

On the other hand, the introducing member 23 is provided at a position in the prism unit closer to the side surface of the container 11 than the covering member 22 when viewed from the chute 12 of the container 11. With the introducing member 23, the toner dropped from the chute 12 is introduced from the inlet 23a to the prism unit 13 and is moved downwardly while being guided by the introducing member 23.

The outlet 24 is provided on the covering member 22 of the prism unit 13 at a position lower than the inlet 23a in the direction of gravity. The outlet 24 is used for discharging the toner introduced to the covering member 22. Thus, during a small amount of toner is accumulated in the container 11, the toner drops from the outlet 24 and moves downward in the container 11. On the other hand, when the amount of the toner is becoming large, the toner introduced from the chute 12 accumulates at the lower part of the container 11 and the accumulated toner blocks the lower side of the chute 24.

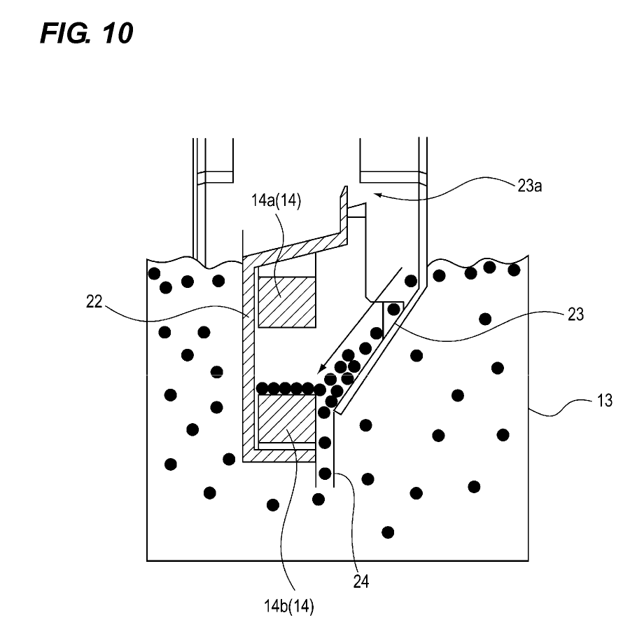

FIG. 10 is a view showing a state in which the collected toner reaches a predetermined amount. As shown in FIG. 10, the toner introduced from the inlet 23a after the outlet 24 is blocked is gradually deposited above the outlet 24. Then, the toner conveyed along the introducing member 23 is deposited on the second prism 14b while maintaining the repose angle β as described below. When the toner deposited on the second prism 14b covers the detection area 20, the optical path K of the detection light is blocked (see FIG. 5) and the detection light emitted from the light emitting element 18 does not reach the light receiving element 19, thereby it is detected that the toner in the toner container 11 has reached a predetermined amount.

As indicated in FIG. 9, the straight line L connects the closest point (reference point P1) to the inlet 23a on the lowermost surface of the first prism 14a and the farthest point (reference point P2) from the inlet 23a on the topmost surface of the second prism 14b. The angle formed between the straight line L and horizontal direction is defined as θ. In this embodiment, the angle θ is determined as follows.

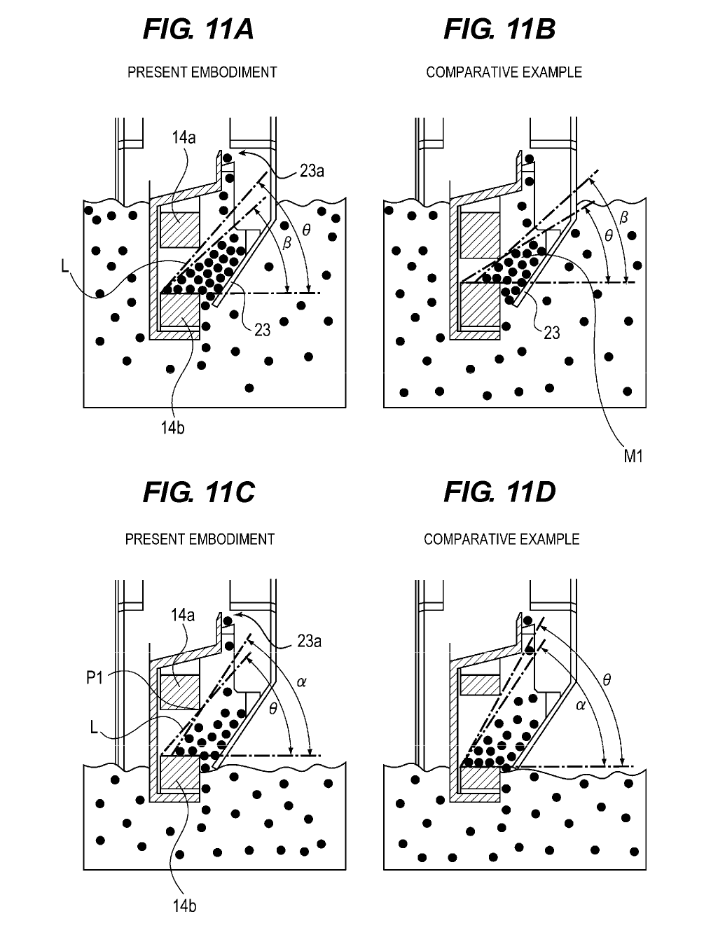

FIGS. 11A, 11B, 11C and 11D are diagrams showing concrete positional relationships between the prisms. Each of the FIGS. is a sectional view (vertical sectional view or a sectional view perpendicular to opposing surfaces of the first prism 14a and the second prism 14b which are opposed to each other) at a position including the first prism 14a of the prism unit 13, the second prism 14b of the prism unit 13 and the inlet 23a. FIGS. 11A and 11B are diagrams showing the relationships between the repose angle β and the angle θ. FIGS. 11C and 11D are diagrams showing the relationships between the diffusion angle α and angle θ. FIGS. 11A and 11C indicate the embodiment of the present invention and FIGS. 11B and 11D indicate a comparative example for explanation.

The relationship between the angle θ and the repose angle β to be set will be explained with reference to FIGS. 11A and 11B. In this embodiment, as shown in FIG. 11A, it is necessary for the positional relationship to satisfy the condition of the angle θ>the repose angle β. Next, detailed explanation will be made.

As shown in FIG. 11A, when the toner is deposited on the second prism 14b at the repose angle β and the foot of the mountain formed by the deposition of the toner covers the entire area of the second prism 14b, the optical path from K (see FIG. 5) from the reflective sensor 17 is blocked. This makes it possible to detect the presence of toner.

In a vertical section including the first prism 14a and the second prism 14b, the straight line L connects the closest point to the inlet 23a on the lower surface of the first prism 14a and the farthest point from the inlet 23a on the top surface of the second prism 14b. The angle formed between the straight line L and horizontal direction is defined as θ. In this case, the angle θ should be greater than the repose angle β. The reason for this is as follows.

When the angle θ is smaller than the repose angle β, the upper portion of the toner mountain M1 becomes in contact with the first prism 14a before the foot of toner mountain M1 deposited on the second prism 14b at the repose angle β covers the entire area of the second prism 14b (see FIG. 11B). Then, when the toner is deposited thereafter, the toner mountain M1 becomes higher but it does not follow that the foot area of the toner mountain M1 deposited on the second prism 14b is widened. For this reason, the foot of the toner mountain M1 cannot cover the entire area of the second prism 14b. Thus, to prevent the upper portion of the deposited toner mountain M1 from becoming in contact with the first prism 14a, it is necessary to satisfy the relationship of the angle θ>the repose angle β as shown in FIG. 11A.

Next, the relationship between the angle θ and the diffusion angle α to be set will be described with reference to FIGS. 11C and 11D. As shown in FIG. 11C, the toner introduced from the inlet 23a falls while spreading at the diffusion angle α. In this embodiment, as shown in FIG. 11C, it is necessary for the positional relationship to satisfy the condition of the diffusion angle α>angle θ. Then, the detailed explanation will be made.

When the straight line which passes through the reference point P1 of the first prism 14a is drawn at the diffusion angle α, the straight line intersects the top surface of the second prism 14b. That is, the range in which the toner diffuses from the inlet 23a while falling does not cover the entire top area of the second prism 14b. Then, the toner dropped from the inlet 23a does not cover the entire area of the detection surface of the second prism 14b directly. Therefore, it is possible to prevent an early detection.

In case of the angle θ being larger than the diffusion angle a, when the toner dropped from the inlet 23a diffuses, the toner directly reaches the entire area of the second prism 14b. Then, there is a possibility that the developer amount detecting system 100 does an early detection of the toner since the toner directly covers the detection surface of the second prism 14b without going through the process of being accumulated at the introducing member 23. To prevent this, it is necessary for the positional relationship to satisfy the condition that the diffusion angle α>the angle θ as described above.

Taken together the above considerations, in this embodiment, the angle θ formed between the straight line L connecting the reference point P2 of the second prism 14b and the reference point P1 of the first prism 14a and the horizontal direction, the toner diffusion angle α and the toner repose angle β have the relational expression that the diffusion angle a α>the angle θ>the repose angle β.

By satisfying the above relational expression in all cross-sections including the first prism 14a and the second prism 14b of the prism unit 13, even if the toner is variously deposited in the prism unit 13, an erroneous detection can be prevented.

As described above, with the arrangement which satisfy the above relational expression, it is possible to prevent erroneous detections due to the accumulation of toner or the scattered toner and to surely detect that the toner reaches a predetermined amount.

In the present embodiment, the first prism 14a is placed at an upper position in vertical direction and the second prism 14b is placed at a lower position in the vertical direction. However, the present invention is not limited to this configuration. For example, the first prism 14a may be disposed at a lower position in vertical direction and the second prism 14b may be disposed at an upper position in the vertical direction. In this case, in a vertical cross-section including the first prism 14a and the second prism 14b, the point closest to the inlet 23a (the reference point P1 in the above embodiment) corresponds to an end portion at the inlet 23a side of the second prism 14b disposed at the upper position. Also, the farthest point from the inlet 23a (the reference point P2 in the above embodiment) corresponds to an end portion at the farther side from the inlet 23a of the first prism 14a disposed at the lower position.

As described above, according to the present invention, the toner can be properly deposited to the detection unit for detecting that the toner reaches a predetermined amount.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2014-101987, filed May 16, 2014, which is hereby incorporated by reference herein in its entirety.

What is claimed is:

1. A developer container, comprising:
an accommodating portion which is able to accommodate developer;
a collecting aperture for collecting developer in the accommodating portion;
an optical unit which is disposed at a position lower than the collecting aperture in the accommodating portion in the direction of gravity, the optical unit forming an optical path for guiding detection light which detects developer,
wherein the optical unit includes:
a first optical unit which forms an optical path for guiding detection light inside the accommodating portion;
a second optical unit which is disposed so as to be opposed to the first optical unit, and which forms an optical path for guiding the detection light guided by the first optical unit to the outside of the accommodating portion;
a space provided at the optical path between the first optical unit and the second optical unit, and in which the developer is able to accumulate; and
a casing portion which has an opening for communicating with the space, and which covers the peripheral of the space, the opening being provided at a position higher than the space in the direction of gravity;
an outlet which is disposed at a position lower in the direction of gravity than the space, and through which the developer guided into the casing portion is discharged, and
wherein the first optical unit and the second optical unit are configured such that an angle formed by a straight line connecting a point closest to the opening on opposed surface areas of the first optical unit and the second optical unit and a point farthest from the opening on the opposed surface areas, and the opposed surface areas is greater than the repose angle of the developer.

2. The developer container, according to claim1,
wherein the first optical unit and the second optical unit are configured such that the angle formed by the straight line and the opposed surface areas is smaller than the diffuse angle of the developer.

3. An image forming apparatus, comprising:
an image forming unit which forms an image; and
the developer container according to claim 1.

4. An image forming apparatus, comprising:
an image forming unit which forms an image; and
the developer container according to claim 2.

5. An optical unit which forms an optical path for guiding detection light which detects developer, comprising:
a first optical unit which forms an optical path for guiding detection light inside the accommodating portion;
a second optical unit which is disposed so as to be opposed to the first optical unit, and which forms an optical path for guiding the detection light guided by the first optical unit to the outside of the accommodating portion;
a space provided at the optical path between the first optical unit and the second optical unit, and in which the developer is able to accumulate;
a casing portion which has an opening for communicating with the space, and which covers the peripheral of the space; and
an outlet through which the developer guided into the casing portion is discharged,
wherein the first optical unit and the second optical unit are configured such that an angle formed by a straight line connecting a point closest to the opening on opposed surface areas of the first optical unit and the second optical unit and a point farthest from the opening on the opposed surface areas, and the opposed surface areas is greater than the repose angle of the developer.
